(19) United States
(12) Patent Application Publication
(10) Pub. No.: US 2007/0171206 A1
(43) Pub. Date: Jul. 26, 2007

(54) 2-in-1 terminal having turnable display

(75) Inventor: Sami Maala, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 10/926,848

(22) Filed: Aug. 25, 2004

(51) Int. Cl. G09G 5/00

(52) U.S. Cl. 345/169; 345/156

(57) ABSTRACT

A method and apparatus are provided for viewing a display arranged on a mounting assembly of a terminal, wherein the display turns or rotates in the mounting assembly so as to enable viewing of the display on either the frontside or backside of the terminal. Covers are arranged on a housing of the terminal for sliding to cover or uncover the display. The slidable covers include each a joystick mounted thereon for providing a user interface with content being viewed on the display. The covers may be arranged on the backside of the terminal, and may include a keyboard arranged thereon for providing a user interface with content being viewed on the display.

### BACKGROUND OF THE INVENTION

1. Field of Invention

The present invention relates to a method and apparatus for viewing a display arranged on a mounting assembly of a terminal, such as a mobile phone or other suitable wireless device or node; and more particularly to a method and apparatus for viewing a display arranged on a mounting assembly of a terminal so as to enable selective viewing of the display on either the frontside or backside of the terminal.

2. Description of Related Art

It is known in the prior art to rotate or turn a display in a terminal. See, for example, U.S. patent application Ser. No. 10/278,048, filed Oct. 21, 2002, entitled “Mobile Device Featuring 90 Degrees Rotatable Front Cover for Covering or Revealing a Keyboard”, which relates to a device having a hingeable display that rotates about a corner axis in the plane of the display itself, and is hereby incorporated by reference in its entirety. However, none of these terminals have displays that can be turned or rotated 180 degrees to enable selective viewing of the display on either the frontside or backside of the terminal.

Moreover, devices are known, such as the Vodafone Model no. V0809, that have sliding cover parts for covering and uncovering a display. However, the Vodafone Model no. V0809 does not have a 180 degrees turnable or rotatable display.

### SUMMARY OF INVENTION

In its broadest sense, the present invention provides a new and unique method and apparatus for viewing a display arranged on a mounting assembly of a terminal, wherein the display turns or rotates in the mounting assembly so as to enable viewing of the display on either the frontside or backside of the terminal.

One or more covers may be arranged on a housing of the terminal for sliding to cover or uncover the display. The one or more covers may include a joystick mounted thereon for providing a user interface with content being viewed on the display. The one or more covers may be arranged on the backside of the terminal, and may include a keyboard arranged thereon for providing a user interface with content being viewed on the display.

In operation, the display includes a user interface device. When the display is turned or rotated 180 degrees to the backside by the user, the terminal may operate in one mode of operation. In comparison, when the display is turned or rotated 180 degrees to the frontside by the user, the terminal may operate in a different mode of operation. For example, when the display is turned or rotated to the frontside by the user, the terminal can be used in a vertical orientation by the user as a normal terminal in a normal or closed mode. In this case, the terminal may have a frontside portion having a keyboard arranged thereon. In comparison, when the display is turned or rotated to the backside by the user, the terminal can be used in a horizontal orientation by the user as a games/communicator terminal in a games/communicator or open mode. In this case, the terminal may also have the one or more covers arranged on the housing for sliding to cover or uncover the display, each having a joystick mounted thereon for providing a user interface with content being viewed on the display. In the games/communicator or open mode, the cover would be moved to a position to uncover the display. In still another embodiment, the terminal may include two covers, each having a respective joystick mounted thereon, on the backside of the terminal.

The display has opposing sides that are pivotally coupled to mounting members of the mounting assembly for turning or rotating 180 degrees.

The present invention also features the terminal itself featuring the mounting assembly with the display arranged thereon, wherein the display turns or rotates in the mounting assembly so as to enable viewing of the display on either the frontside or backside of the terminal.

One advantage of the present is that the terminal may be used as a normal terminal in a closed mode, and a games/communicator terminal in an open mode that enables games to be played in a more convenience format.

### BRIEF DESCRIPTION OF THE DRAWING

The drawing, not drawn to scale, includes the following Figures:

FIG. 1 shows a block diagram of a terminal or other suitable wireless mobile phone, device or node according to the present invention.

FIG. 2 shows a terminal according to the present invention when used in a vertical orientation, and includes FIG. 2a that is a diagram of the front of the terminal having the display turned or rotated for viewing on the frontside of the terminal according to the present invention, and also include FIG. 2b is a diagram of the back of the terminal shown in FIG. 2a with the sliding covers in the closed position according to the present invention.

FIG. 3 shows a terminal according to the present invention when used in a horizontal orientation, and includes FIG. 3a that is a diagram of the back of the terminal in the closed position, and also include FIG. 3b that is a diagram of the back of the terminal shown in FIG. 3a with the sliding covers in the open position having the display turned or rotated for viewing on the backside of the terminal according to the present invention.

### DETAILED DESCRIPTION OF INVENTION

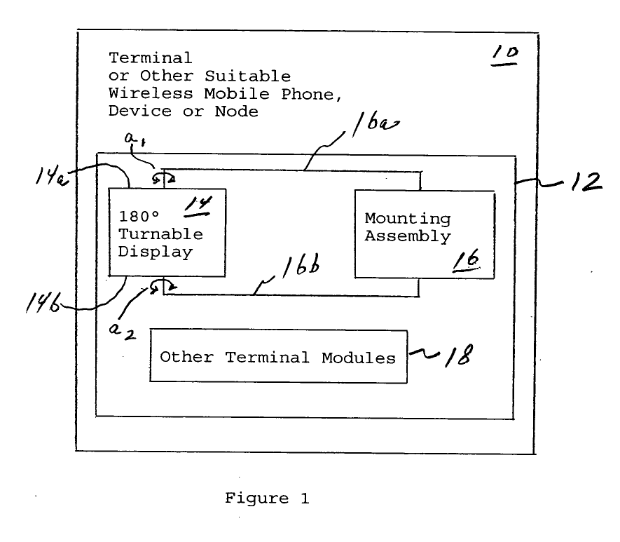

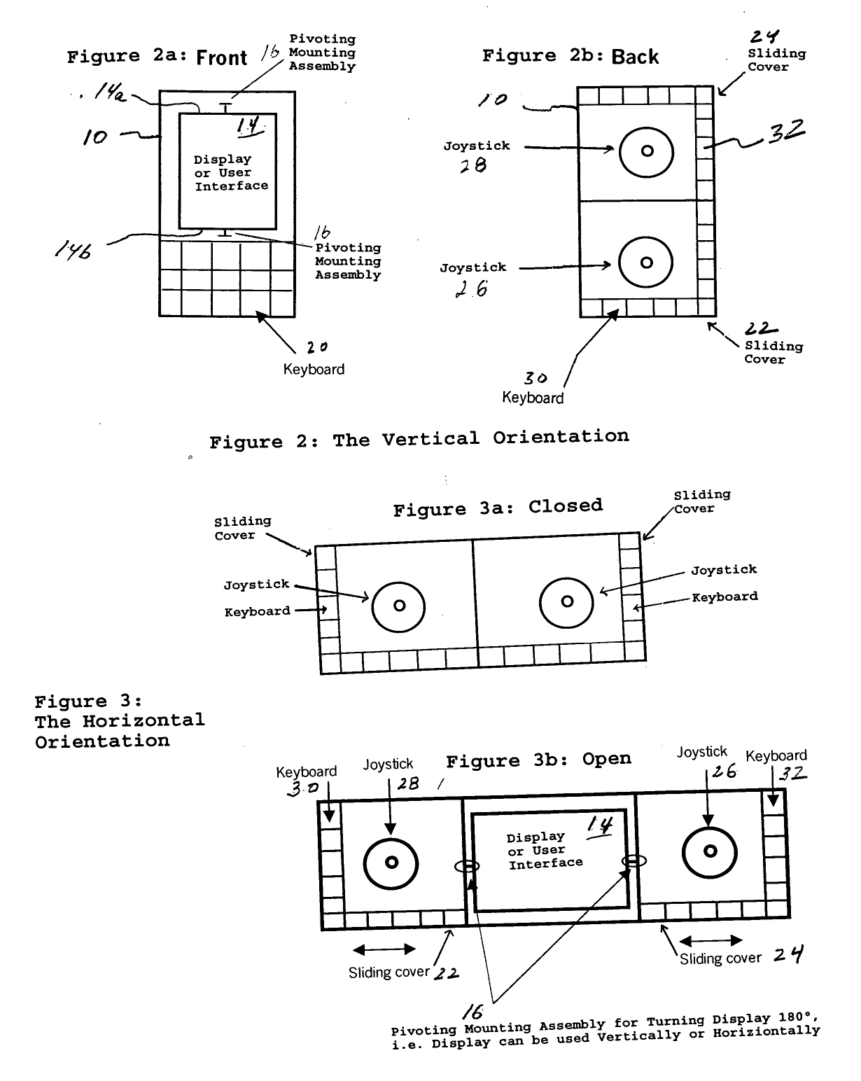

FIG. 1 shows a terminal or other suitable wireless mobile phone, device or node generally indicated as 10 including a housing indicated as 12, a display 14 and a mounting assembly 16. According to the present invention, the display 14 turns or rotates in the mounting assembly 16 so as to enable viewing of the display 14 on either the frontside (See FIG. 2a) or backside (See FIG. 3b) of the terminal 10. In particular, when the display 14 is turned or rotated 180 degrees to the frontside of the terminal 10 by the user as shown in FIGS. 2, 2a, 2b, the terminal 10 may be operated in a normal mode of operation as a terminal device, such as a mobile phone or other suitable wireless communicator or device. In comparison, when the display 14 is turned or rotated 180 degrees to the backside of the terminal 10 by the user as shown in FIGS. 3, 3a, 3b, the terminal 10 may be operated in a different mode of operation, such as a gaming device or other suitable communicator terminal.

Displays like element 14 are known in the art, and the scope of the invention is not intended to be limited to any particular type or kind now known or developed in the future. As shown, the display may include a user interface device for receiving touch screen inputs from a user, as well as non-touch sensitive displays like an LCD or similar display device.

Mounting assemblies such as element 16 are known in the art, and the scope of the invention is not intended to be limited to any particular type or kind now known or developed in the future. As shown, the mounting assembly 16 includes mounting members 16a, 16b or other suitable coupling members for pivotally coupling to opposing sides 14a, 14b of the display 14 for turning or rotating the same 180 degrees as indicated by arrows a₁, a₂. Moreover, the scope of the invention is intended to include either the housing 12 and the mounting assembly 16 being formed as separate components with the display 14 being mounted on the mounting assembly 16 which in turn is mounted to the housing 12, or embodiments in which the housing 12 and the mounting assembly 16 are formed as one integral component. In other words, the scope of the invention is not intended to be limited to the manner or way in which the display 14 is pivotally mounted in the terminal 10.

### FIG. 2: The Vertical Orientation for a Normal Mode of Operation

FIG. 2 shows the terminal 10 according to the present invention when typically used in a vertical orientation for operating in the normal mode of operation. The terminal 10 includes a front or frontside shown in FIG. 2a and a back or backside shown in FIG. 2b.

In FIG. 2a, the display 14 is turned or rotated for viewing on the frontside of the terminal 10. The frontside of the terminal 10 is shown, by way of example, with a keyboard 20, although the scope of the invention is not intended to be limited to only the same. Embodiments are envisioned with the frontside of the terminal 10 having other types or kinds of user interface devices, such as one or more control buttons, speakers, microphones, all not shown, as well as other types or kinds of user interfaces now known or later developed in the future. The scope of the invention is also intended to include the frontside of the terminal 10 having other types or kind of non-user interface devices.

FIG. 2b shows the backside of the terminal 10, which includes two sliding covers 22, 24 in a closed position according to the present invention, which are arranged on the housing 12 (FIG. 1) for sliding to cover or uncover the display 14. Each cover 22, 24 includes a respective joystick 26, 28 mounted thereon for providing a user interface with content being viewed by the user on the display 14, as well as for operating the terminal in a normal mode of operation. Each cover also includes a respective keyboard 30, 32 arranged thereon for also providing a user interface with the content being viewed on the display 14, as well as for operating the terminal in the normal mode of operation. Similar to that discussed above, the terminal 10 is shown, by way of example, with the joysticks 26, 28 and the keyboards 30, 32, although the scope of the invention is not intended to be limited to only the same. For example, embodiments are envisioned with the covers 22, 24 having other types or kind of user interface devices, such as control buttons or the like, as well as other types or kinds of user interfaces now known or later developed in the future. The scope of the invention is also not intended to be limited to the number or position of the joysticks 26, 28 and the keyboards 30, 32 on the covers 24, 26, or the arrangement thereof in relation to one another.

### FIG. 3: The Horizontal Orientation for a Games/Communicator Mode of Operation

FIG. 3 shows the terminal 10 according to the present invention when typically used in a horizontal orientation for operating in the gaming mode of operation. FIG. 3a shows the closed position, which is similar to that shown in FIG. 2b (i.e. vertical orientation). In comparison, FIG. 3b shows the terminal 10 in the open position for using it in the gaming mode of operation.

In FIG. 3b, the display 14 is turned or rotated 180 degrees to the backside of the terminal 10 by the user in relation to that shown in FIG. 2a, so the terminal 10 can be used in the horizontal orientation by the user as the games/communicator terminal in the games/communicator or open mode. The terminal 10 has the two covers 30, 32, each having the respective joystick 26, 28 mounted thereon on the backside thereof, in the open position. As shown, the display 14 is arranged in the middle of the terminal 10, and the two covers each slide to uncover the display, embodiments are envisioned in which the terminal includes one cover such as cover 30 or 32 which covers are uncovers the display. The scope of the invention is not intended to be limited to the position of the display in relation to the device, or the number of covers used to cover or uncover the display.

### Other Terminal Modules 18

The terminal 10 may also include other terminal modules 18 (FIG. 1) that are now known or later developed in the future, but do not necessarily form part of the basic invention disclosed herein, including a processing and/or module, a memory module, input/output modules, a speaker module, a microphone module, etc.

### Other Embodiments

The scope of the invention is intended to include either the frontside or backside mode of operation of the terminal being determined by a user input to the terminal when using the terminal in either the vertical or horizontal mode, as well as the frontside or backside mode of operation being determined by default by a switch (not shown) that is actuated the turning or rotating of the display 14 from the frontside position to the backside position when using the terminal in either the vertical or horizontal mode. In the later case, the other terminal modules may also include a frontside/backside mode module that receives a control signal from the switch (not shown) and operates the terminal in either the frontside or backside mode of operation. The functionality of the frontside/backside mode module may be implemented in or part of one or more of the other terminal modules 18.

Alternatively, the functionality of such a frontside/backside mode module may be implemented as a separate module using hardware, software, firmware, or a combination thereof. In a typical software implementation, the frontside/backside mode module would be one or more microprocessor-based architectures having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation. The scope of the invention is not intended to be limited to any particular implementation using technology known or later developed in the future.

### Scope of the Invention

The present invention is shown and described in relation to a terminal having two sides, including a frontside and a backside. However, embodiments are envisioned using a terminal having more than two sides, such as three or four sided terminals. The scope of the invention is intended to cover these types and other types of terminals as well.

The scope of the invention is not intended to be limited to any specific kind of device or user equipment, mobile terminal, phone or devices, and many different mobile terminals or devices, including laptop or notebook computers, as well as PDAs and tablet PCs, are envisioned that may contain the fundamental features of the present invention described herein.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method for viewing a display arranged on a mounting assembly of a terminal, characterized in that
the display turns or rotates in the mounting assembly so as to enable viewing of the display on either the frontside or backside of the terminal.

2. A method according to claim 1, wherein the method further comprises arranging one or more covers on a housing of the terminal for sliding to cover or uncover the display.

3. A method according to claim 2, wherein the one or more covers include a joystick mounted thereon for providing a user interface with content being viewed on the display.

4. A method according to claim 2, wherein the one or more covers are arranged on the backside of the terminal.

5. A method according to claim 2, wherein the one or more covers include a keyboard arranged thereon for providing a user interface with content being viewed on the display.

6. A method according to claim 1, wherein the display includes a user interface device, including a touch screen device or other suitable display device.

7. A method according to claim 1, wherein, when the display is turned or rotated 180 degrees to the backside, the terminal may be operated in one mode of operation; and when the display is turned or rotated 180 degrees to the frontside, the terminal may be operated in a different mode of operation.

8. A method according to claim 1, wherein, when the display is turned or rotated 180 degrees to the frontside, the terminal can be used in a vertical orientation by the user as a normal terminal in a closed or normal mode.

9. A method according to claim 8, wherein the terminal has a frontside portion having a keyboard arranged thereon.

10. A method according to claim 1, wherein, when the display is turned or rotated 180 degrees to the backside, the terminal can be used in a horizontal orientation by the user as a games/communicator terminal in a games/communicator or open mode.

11. A method according to claim 9, wherein the terminal further comprises one or more covers arranged on a housing of the terminal for sliding to cover or uncover the display.

12. A method according to claim 10, wherein the one or more covers include a joystick mounted thereon for providing a user interface with content being viewed on the display.

13. A method according to claim 10, wherein the one or more covers include two covers, each having a respective joystick mounted thereon.

14. A method according to claim 10, wherein the display has opposing sides that are pivotally coupled to mounting members of the mounting assembly for turning or rotating 180 degrees.

15. A terminal having a mounting assembly with a display arranged thereon, characterized in that
the display turns or rotates in the mounting assembly so as to enable viewing of the display on either the frontside or backside of the terminal.

16. A terminal according to claim 15, wherein the terminal further comprises one or more covers arranged on a housing of the terminal for sliding to cover or uncover the display.

17. A terminal according to claim 16, wherein the one or more covers include a joystick mounted thereon for providing a user interface with content being viewed on the display.

18. A terminal according to claim 16, wherein the one or more covers are arranged on the backside of the terminal.

19. A terminal according to claim 16, wherein the one or more covers include a keyboard arranged thereon for providing a user interface with content being viewed on the display.

20. A terminal according to claim 15, wherein the display is a user interface device, including a touch screen device or other suitable display device.

21. A terminal according to claim 15, wherein, when the display is turned or rotated 180 degrees to the backside, the terminal may be operated in one mode of operation; and when the display is turned or rotated 180 degrees to the frontside, the terminal may be operated in a different mode of operation.

22. A terminal according to claim 15, wherein, when the display is turned or rotated 180 degrees to the frontside, the terminal can be used in a vertical orientation by the user as a normal terminal in a normal or closed mode.

23. A terminal according to claim 22, wherein the terminal has a frontside portion having a keyboard arranged thereon.

24. A terminal according to claim 15, wherein, when the display is turned or rotated to the backside, the terminal can be used in a horizontal orientation by the user as a games/communicator terminal in a games/communicator or open mode.

25. A terminal according to claim 24, wherein the terminal further comprises one or more covers arranged on a housing of the terminal for sliding to cover or uncover the display.

26. A terminal according to claim 25, wherein the one or more covers include a joystick mounted thereon for providing a user interface with content being viewed on the display.

27. A terminal according to claim 25, wherein the one or more covers include two covers, each having a respective joystick mounted thereon.

28. A method according to claim 25, wherein the display has opposing sides that are pivotally coupled to mounting members of the mounting assembly for turning or rotating 180 degrees.
